(19) United States
(12) Patent Application Publication
(10) Pub. No.: US 2019/0019049 A1
(43) Pub. Date: Jan. 17, 2019

(54) CHARACTER/GRAPHICS RECOGNITION DEVICE, CHARACTER/GRAPHICS RECOGNITION METHOD, AND CHARACTER/GRAPHICS RECOGNITION PROGRAM

(71) Applicant: Panasonic Intellectual Property Management Co., Lt, Osaka (JP)

(72) Inventors: SAKI TAKAKURA, Osaka (JP); MARIKO TAKENOUCHI, Osaka (JP)

(21) Appl. No.: 16/135,294

(22) Filed: Sep. 19, 2018

Related U.S. Application Data
(63) Continuation of application No. PCT/JP2016/004392, filed on Sep. 29, 2016.

(30) Foreign Application Priority Data
Mar. 28, 2016 (JP) 2016-064731

(51) Int. Cl. G06K 9/18; G06K 7/10; G06K 9/62; G06K 9/00; G06K 9/20

(52) U.S. Cl. CPC G06K 9/183; G06K 7/10732; G06K 2009/2045; G06K 9/00463; G06K 9/2027; G06K 9/6202

(57) ABSTRACT

This character/graphics recognition device of the present disclosure obtains information by performing recognition of a character or graphic affixed to an object in a predetermined space. The character/graphics recognition device includes a controller, an imaging unit for capturing an image in a predetermined imaging area including the object, an illumination unit including multiple illumination lamps for emitting light from different positions to illuminate the predetermined space, and a recognition unit for obtaining the information by recognizing the character or graphic in the image captured by the imaging unit and outputting recognition result information including the information obtained.

The controller applies a lighting pattern to the illumination unit and controls a timing to capture the image by the imaging unit, a lighting pattern being a combination of turning on and off of the plurality of illumination lamps.

### BACKGROUND

### Technical Field

The present disclosure relates to a technology for obtaining information from a character/graphics image affixed to an object.

### Description of the Related Art

PTL1 discloses a cooking device configured to read a code affixed to food to be heated and then heat the food. This cooking device is equipped with a camera for reading typically a bar code affixed to food placed in a heating chamber. The food is heated according to information read by the camera.

### CITATION LIST

### Patent Literature

PTL1: Japanese Patent Unexamined Publication No. 2001-349546

### SUMMARY

The present disclosure offers a character/graphics recognition device that obtains an image suitable for obtaining information, regardless of the size or shape of an object, to recognize a character/graphics in the image.

This character/graphics recognition device of the present disclosure obtains information by performing recognition of a character or graphic affixed to an object in a predetermined space. The character/graphics recognition device includes a controller, an imaging unit for capturing an image in a predetermined imaging area including the object, an illumination unit including multiple illumination lamps for emitting light from different positions to illuminate the predetermined space, and a recognition unit for obtaining the information by recognizing the character or graphic in the image captured by the imaging unit and outputting recognition result information including the information obtained. The controller applies a lighting pattern to the illumination unit and controls a timing to capture the image by the imaging unit, a lighting pattern being a combination of turning on and off of the plurality of illumination lamps.

The character/graphics recognition device of the present disclosure acquires an image suitable for obtaining information, regardless of the size or shape of the object, so as to recognize a character or graphic in the image.

### BRIEF DESCRIPTION OF DRAWINGS

FIG. 1 is an outline of a character/graphics recognition device in accordance with a first exemplary embodiment.

FIG. 2 is a block diagram of configuration of the character/graphics recognition device in accordance with the first exemplary embodiment.

FIG. 3 is a flow chart illustrating an outline of the operation for obtaining information by the character/graphics recognition device in accordance with the first exemplary embodiment.

FIG. 4 is a schematic diagram of an example of an image captured by an imaging unit of the character/graphics recognition device in accordance with the first exemplary embodiment.

FIG. 5 is an example of recognition result information output by a recognition unit of the character/graphics recognition device in accordance with the first exemplary embodiment.

FIG. 6A is a flow chart illustrating modification to the operation for obtaining information by the character/graphics recognition device in accordance with the first exemplary embodiment.

FIG. 6B is a flow chart illustrating another modification to the operation for obtaining information by the character/graphics recognition device in accordance with the first exemplary embodiment.

FIG. 7 is correspondence data of an object height range and illumination lamp referred to by the character/graphics recognition device in accordance with the first exemplary embodiment.

FIG. 8 is a flow chart illustrating still another modification to the operation for obtaining information by the character/graphics recognition device in accordance with the first exemplary embodiment.

FIG. 9 is illustrates an outline of character/graphics recognition using a difference image by the character/graphics recognition device in accordance with the first exemplary embodiment.

FIG. 10 is a flow chart illustrating still another modification to the operation for obtaining information by the character/graphics recognition device in accordance with the first exemplary embodiment.

FIG. 11A is a flow chart illustrating still another modification to the operation for obtaining information by the character/graphics recognition device in accordance with the first exemplary embodiment.

FIG. 11B is a flow chart illustrating still another modification to the operation for obtaining information by the character/graphics recognition device in accordance with the first exemplary embodiment.

FIG. 12 is a flow chart illustrating still another modification to the operation for obtaining information by the character/graphics recognition device in accordance with the first exemplary embodiment.

FIG. 13A is a flow chart illustrating still another modification to the operation for obtaining information by the character/graphics recognition device in accordance with the first exemplary embodiment.

FIG. 13B is a flow chart illustrating still another modification to the operation for obtaining information by the character/graphics recognition device in accordance with the first exemplary embodiment.

FIG. 13C is a flow chart illustrating still another modification to the operation for obtaining information by the character/graphics recognition device in accordance with the first exemplary embodiment.

FIG. 14 is an outline of a character/graphics recognition device in accordance with a second exemplary embodiment.

FIG. 15 is a block diagram of configuration of the character/graphics recognition device in accordance with the second exemplary embodiment.

FIG. 16 is a flow chart illustrating an outline of the operation for obtaining information by the character/graphics recognition device in accordance with the second exemplary embodiment.

### DETAILED DESCRIPTION

Exemplary embodiments are described below with reference to drawings. However, detailed description more than necessary may be omitted. For example, duplicate description of details of known issues and practically identical structures may be omitted. This is to avoid unnecessary redundant description and facilitate understanding of those skilled in the art.

Attached drawings and the following description are provided to help those skilled in the art to fully understand the present disclosure. Accordingly, the drawings and description do not restrict in anyway the scope of the present disclosure being indicated by the appended claims.

### First Exemplary Embodiment

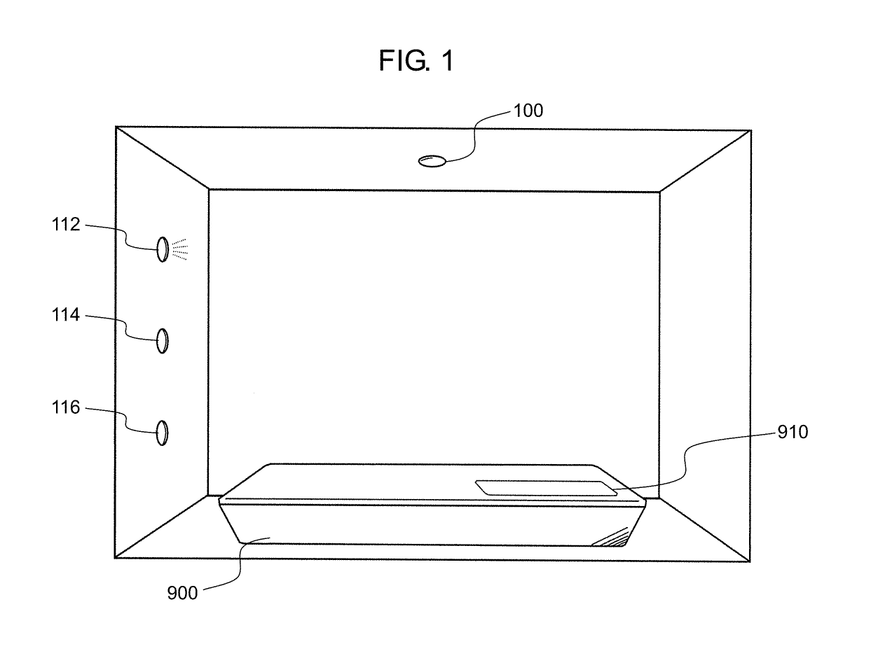

The first exemplary embodiment is described with reference to FIG. 1 to FIG. 10C.

### 1. Outline

FIG. 1 illustrates an outline of a character/graphics recognition device in the first exemplary embodiment.

The character/graphics recognition device in the first exemplary embodiment is a device for obtaining information by recognizing a target character or graphic affixed to an object placed in a predetermined space (hereinafter also referred to as character/graphics recognition, in short). In FIG. 1, a space inside a heating chamber of a microwave oven is given as an example of the predetermined space, and meal box 900 is schematically indicated as an example of the object. Meal box 900 is a commercially-sold meal box, and label 910 indicating product information, such as a product name, expiration date, and heating method, is attached, using characters, symbols, and bar codes. The exemplary embodiment is described below using an example of the microwave oven equipped with the character/graphics recognition device. However, in addition to the microwave oven, the character/graphics recognition device in the exemplary embodiment may be used together with other types of containers having a space for placing an object, such as a coin-operated locker, delivery box, and refrigerator.

The character/graphics recognition device in the first exemplary embodiment obtains product information, including a product name, expiration date, and heating method, by performing character/graphics recognition of an image of this label and outputs the information to the microwave oven. The microwave oven, for example, displays the information on its display unit or automatically heats the meal box based on the information. This reduces user's time spent for setting the output power or heating time to the microwave oven.

FIG. 1 shows imaging unit 100 for capturing the aforementioned image and illumination lamps 112, 114, and 116 for emitting light required for capturing the image inside this space.

Imaging unit 100 is installed at an upper part of the heating chamber in a way such that the space inside the heating chamber is included in an imaging area of imaging unit 100, so as to capture the object from above. The imaging area of imaging unit 100 is fixed to a predetermined imaging area suitable for capturing an image of a label or cover on the object placed inside the heating chamber, such as food for microwave cooking like aforementioned meal box in FIG. 1. In order to broadly support variations, such as object shapes, label positions, and user's object placement direction, the imaging area may be fixed to cover substantially the entire heating chamber.

Illumination lamps 112, 114, and 116 are provided on the side face of the heating chamber such that they can emit light into the heating chamber from positions with different height levels, in order to broadly support shape and height variations of the object placed inside the heating chamber. These illumination lamps 112, 114, and 116 may also function as internal lamps conventionally provided in the microwave oven.

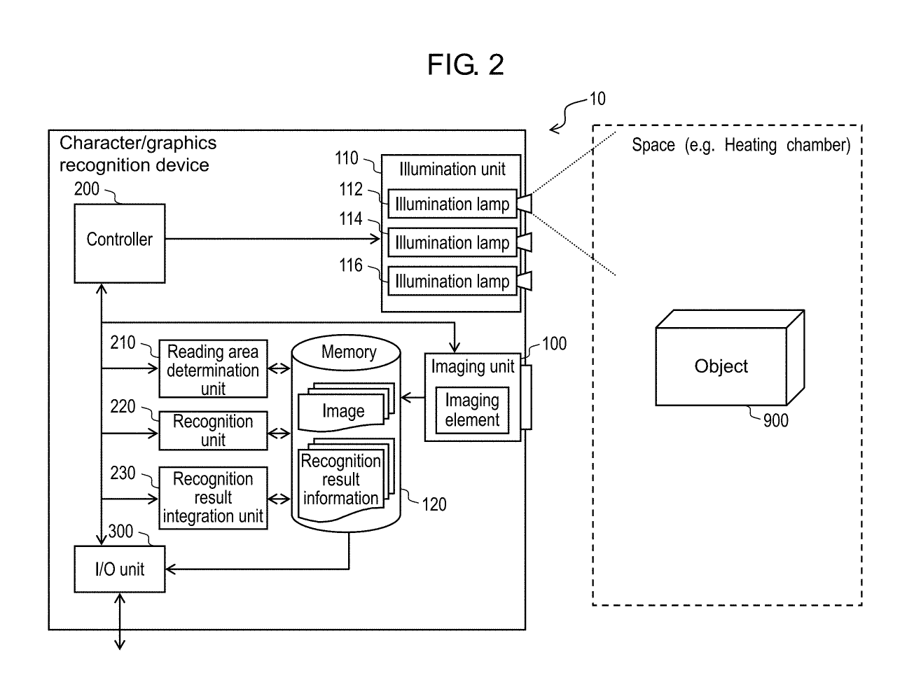

With this character/graphics recognition device provided in the microwave oven, one or more of illumination lamps 112, 114, and 116 are turned on and light is emitted into the heating chamber when the user places meal box 900, for example, in the heating chamber and closes the door. While inside the heating chamber is illuminated by this light, imaging unit 100 captures a top view image of meal box 900, which is the object. Then, character/graphics recognition is applied to characters and graphics in this image to obtain product information, such as a product name, expiration date, and heating method. Next, the configuration for achieving this operation of the character/graphics recognition device is described with reference to FIG. 2.

### 2. Configuration

FIG. 2 is a block diagram of character/graphics recognition device 10 in the first exemplary embodiment.

Character/graphics recognition device 10 includes imaging unit 100, illumination unit 110, memory 120, controller 200, reading area determination unit 210, recognition unit 220, recognition result integration unit 230, and I/O unit 300.

Imaging unit 100 is a component including an imaging element, such as a CMOS (complementary metal-oxide-semiconductor) image sensor, and disposed on the upper part of the aforementioned predetermined space (heating chamber) in a way such that inside the space is included in the photographing area. Controller 200, which is described later, controls imaging unit 100 to capture from above an image of meal box 900 placed in this space. Other than the imaging element, imaging unit 100 includes an optical system including lens.

Illumination unit 110 is a component including multiple illumination lamps 112, 114, and 116 disposed on a side of the predetermined space at different height levels, as described above. Controller 200, which is described later, controls illumination unit 100 to emit light into this space. Imaging unit 100 captures an image, as described above, while illumination unit 110 illuminates the space. In other words, illumination unit 110 functions as a light source used for capturing an image by imaging unit 100 in the predetermined space. For capturing an image, not all illumination lamps 112, 114, and 11 are always turned on. Controller 200 applies a lighting pattern that is a combination of turning on and off of illumination lamps 112, 114, and 116, and the illumination lamps are lighted according to this lighting pattern. Details are described in an example of operation of character/graphics recognition device 10.

Memory 120 is a storage device for storing data of an image captured by imaging unit 100, and also data generated by reading area determination unit 210, recognition unit 220, and recognition result integration unit 230, which are described later. These pieces of data may be output from memory 120 via input/output unit 300 for use outside character/graphics recognition device 10 (e.g., to display in a display unit provided in the microwave oven). Memory 120 further stores a program (not illustrated) to be read and executed by controller 200 and reference data (not illustrated). This memory 120 is typically a semiconductor memory. Memory 120 may not be a storage device exclusive for character/graphics recognition device 10. For example, it may be part of a storage device typically for the microwave oven equipped with character/graphics recognition device 10.

Controller 200 reads out and executes the above program stored in memory 120 for operation. Controller 200 controls imaging unit 100 and operates illumination unit 110, as described above, by executing the above program.

Reading area determination unit 210, recognition unit 220, and recognition result integration unit 230 are functional components provided and controlled by controller 200 executing the above program, so as to execute the operation described later. This controller 200 is achieved typically by a microprocessor. Controller 200 may not be a microprocessor exclusive for character/graphics recognition device 10. For example, it may be a microprocessor for controlling overall operations typically of the microwave oven equipped with character/graphics recognition device 10.

Reading area determination unit 210 determines a reading area including a target of character/graphics recognition in an image, based on pixel values of pixels contained in this image captured by imaging unit 100. For example, the reading area is an area in which an image of label 910 is photographed in the image captured by imaging unit 100. The target of character/graphics recognition is a character, symbol, bar code, or graphic, such as 2D code, indicated on label 910.

Recognition unit 220 performs character/graphics recognition in the reading area determined by reading area determination unit 210 to obtain product information, including a product name, expiration date, and heating method, indicated typically by a character, symbol, and bar code in this reading area. Recognition unit 220 outputs these pieces of product information as recognition result information, and memory 120 stores the information. In addition to obtaining the above product information, recognition unit 220 may calculate accuracy of each piece of information. This accuracy may also be included in the recognition result information and stored in memory 120. This product information is an example of information recognized and obtained by recognition unit 220 in the present disclosure.

Recognition result integration unit 230 integrates these pieces of product information obtained by recognition unit 220, based on the above accuracy. Details are described later.

Input/output unit 300 is an interface for receiving and sending data between character/graphics recognition device 10 and its external device, such as a microwave oven. For example, a request for a character/graphics recognition result may be input from the microwave oven to character/graphics recognition device 10 via input/output unit 300. Character/graphics recognition device 10 may then perform character/graphics recognition in response to this request, and output the recognition result information.

### 3. Example of Operation

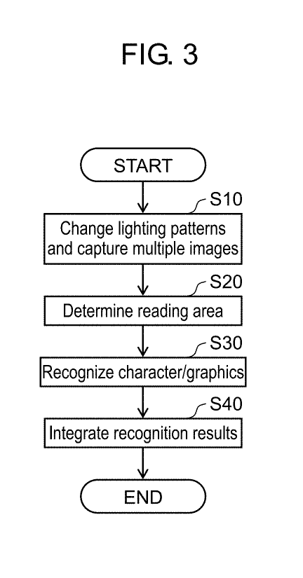

The operation of character/graphics recognition device 10 as configured above is described below. FIG. 3 is a flow chart illustrating an example of the flow of operation of character/graphics recognition device 10. The operation is triggered when, for example, controller 200 receives a request for the character/graphics recognition result from the microwave oven that has received user's input of instruction for starting auto-heating, or detected closing of its door after a heating object is placed in the heating chamber.

As shown in FIG. 3, the operation of character/graphics recognition device 10 is roughly divided to four steps: Capturing an object (Step S10), determining a reading area in the image (Step S20), recognizing a character or graphic in the reading area (Step S30), and integrating recognition results (Step S40). Each step is detailed below with reference to the example of the microwave oven equipped with the character/graphics recognition device, same as above.

### 3-1. Capturing an Image

In Step S10, controller 200 turns on one of illumination lamps 112, 114, and 116 to illuminate the heating chamber in which the object is placed by applying one of lighting patterns to illumination unit 110. Assume that controller 200 makes illumination unit 110 turn on illumination lamp 112 at the highest position in the heating chamber. Controller 200 then makes imaging unit 100 capture an image in a predetermined imaging area while illumination unit 110 illuminates the heating chamber using illumination lamp 112.

Next, controller 200, by applying another lighting pattern, makes illumination unit 110 turn on an illumination lamp different from illumination lamp 112 to illuminate inside the heating chamber in which the object is placed. Assume that controller 200 makes illumination unit 110 turn on illumination lamp 114. Controller 200 then makes imaging unit 100 capture an image in the same imaging area as before while illumination unit 110 illuminates inside the heating chamber using illumination lamp 114.

Next, controller 200, by applying still another lighting pattern, makes illumination unit 110 turn on an illumination lamp different from both illumination lamp 112 and illumination lamp 114. More specifically, the illumination lamp is switched to illumination lamp 116 to illuminate inside the heating chamber in which the object is placed. Controller 200 then makes the imaging unit 100 captures an image in the same imaging area as before while illumination unit 110 illuminates inside the heating chamber using illumination lamp 116.

In this way, inside the heating chamber is illuminated using illumination lamps at different height levels successively, and multiple images in the same imaging area are captured. Memory 120 stores data of captured images.

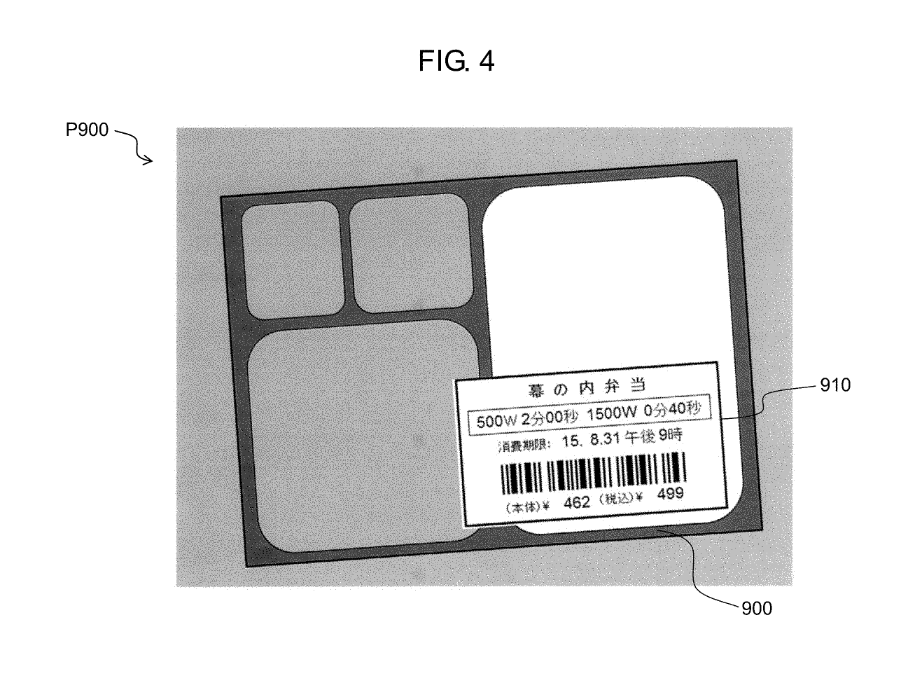

FIG. 4 shows image P900 that is an example of an image captured by imaging unit 100. Image P900 includes meal box 900 to which label 910 is attached and the inner bottom face of the heating chamber at its back. Image P900 in FIG. 4 is an image in which all characters and graphics including symbol and bar code that are the target of character/graphics recognition are clearly captured and is suitable for processing in subsequent steps. However, the whole or part of captured image may be too bright or dark and not suitable for character/graphics recognition, depending on the size, shape, position, and direction of the object and the illumination lamp illuminated for imaging (applied lighting pattern). In the description below, an image not suitable for character/graphics recognition is assumed to be contained in multiple images captured as above.

### [3-2. Determining a Reading Area]

In Step S20, reading area determination unit 210 obtains data of multiple images captured by imaging unit 100 from memory 120, and determines a reading area in these images.

The reading area is, in this example, an area where an image of label 910 is shown in the image. In this kind of label 910, characters and graphics that are the target of character/graphics recognition are often indicated in solid black, and a portion (background) other than characters and graphics is often a flat area with a plain color, such as white. In an area other than label 910, various colors of ingredients and container of meal box are often photographed or shading due to uneven surface is often present. Reading area determination unit 210 can determine a reading area based on pixel values using a known method, utilizing this difference in appearance between label 910 and other portion.

For example, an area where an image of label 910 is present is detected, based on color information of each pixel in the image, and the detected area may be determined as the reading area. Another example is to detect pixels forming an image of characters and graphics, based on color information of each pixel in the image, and an area where detected characters and graphics gather may be determined as the reading area. Still another example is to determine an area surrounded by an edge of the label image as the reading area, based on a difference in pixel values (edge) of adjacent pixels in the image. Further another example is to detect pixels forming an image of characters and graphics, based on edge, and an area where these detected images of characters or graphics gather may be determined as the reading area.

After the reading area is determined, reading area determination unit 210 includes information on the determined reading area in original image data or another image data obtained by conversion, or in the form of different piece of data related to the original image data, and outputs and stores the information in memory 120. Reading area determination unit 210 may output and store information indicating accuracy of this reading area, in addition to information indicating the determined reading area.

### 3-3. Recognizing a Character or Graphic

In Step S30, recognition unit 220 obtains data stored by reading area determination unit 210 from memory 120. Recognition unit 220 obtains information by performing character/graphics recognition of characters and graphics in the reading area indicated by this data. Recognition unit 220 can perform character/graphics recognition using a known method.

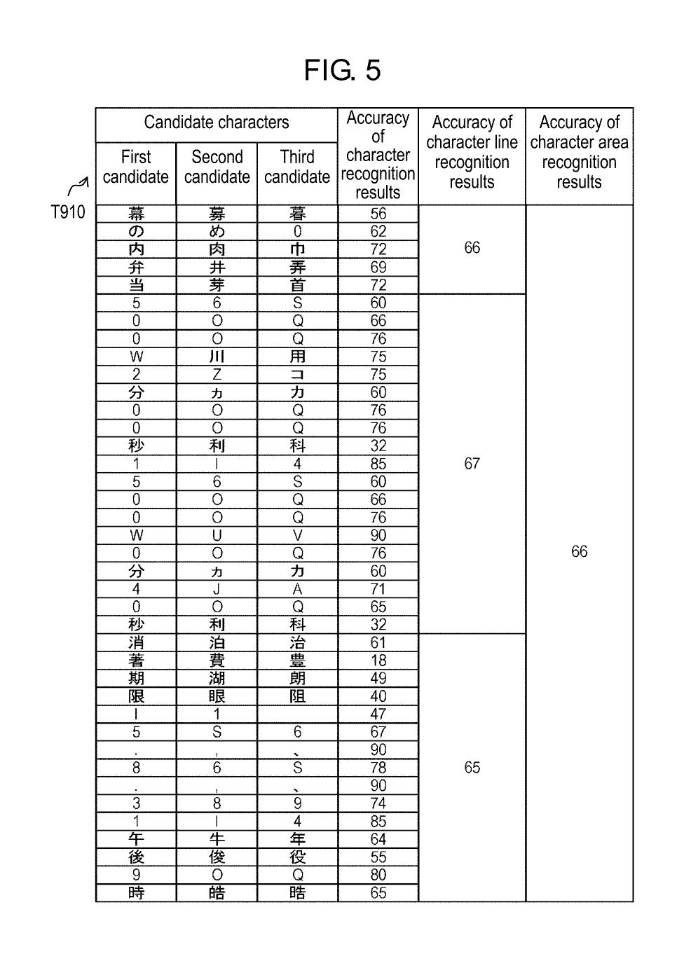

After obtaining information by performing character/graphics recognition, recognition unit 220 outputs this information as recognition result information to store it in memory 120. Recognition unit 220 may include accuracy of obtained information in this recognition result information. FIG. 5 shows an example of the recognition result information output from recognition unit 220, including the information obtained by character recognition and its accuracy. In this example, candidates of characters (hereinafter including numbers and symbols) recognized as the information obtained, candidates of each character recognized, and accuracy of a predetermined group of these candidate characters (each line and entire area) are output in a format of table T910 as the recognition result information.

When Step S30 is applied to a graphic, such as a bar code, elements, such as lines, constituting the graphic in the reading area are recognized. A characteristic (e.g., line thickness and interval) of the graphic identified by this recognition is decoded according to predetermined rules, and characters or candidates obtained by this decoding are included as the information obtained in the recognition result information. Also in this case, accuracy of the information obtained may be included in the recognition result information.

### 3-4. Integrating Recognition Results

In Step S40, recognition result integration unit 230 obtains data of the recognition result information stored by recognition unit 220 from memory 120. Recognition result integration unit 230 integrates recognition result information in the data to obtain final information.

As an example of integration, recognition result integration unit 230 obtains and compares the reading areas of images and accuracy of recognition result information of three reading areas determined based on three images in the above example (values at the rightmost column in Table T910 in FIG. 5). The recognition result information with the highest accuracy may then be selected. Selected recognition result information is output to the microwave oven via input/output unit 300.

Another example is to compare accuracy of each character (values in the third column from the right in Table T910 in FIG. 5) in the recognition result information. A result with the highest accuracy may be selected for each character or a result with the highest accuracy may be selected for each line using the line accuracy (values in the second column from the right in Table T910 in FIG. 5). In this case, selected characters or lines are collected to generate new recognition result information, and this new recognition result information is output to the microwave oven via I/O unit 300.

### 4. Modifications to the Operation

The above operation of character/graphics recognition device 10 is one example, and thus the present disclosure is not limited to the above operation.

Modifications to the above operation are shown below. Common steps are given the same reference marks, and their description is omitted. Description below centers on points that differ from the above operation.

### 4-1. Modification for Selecting an Optimum Image

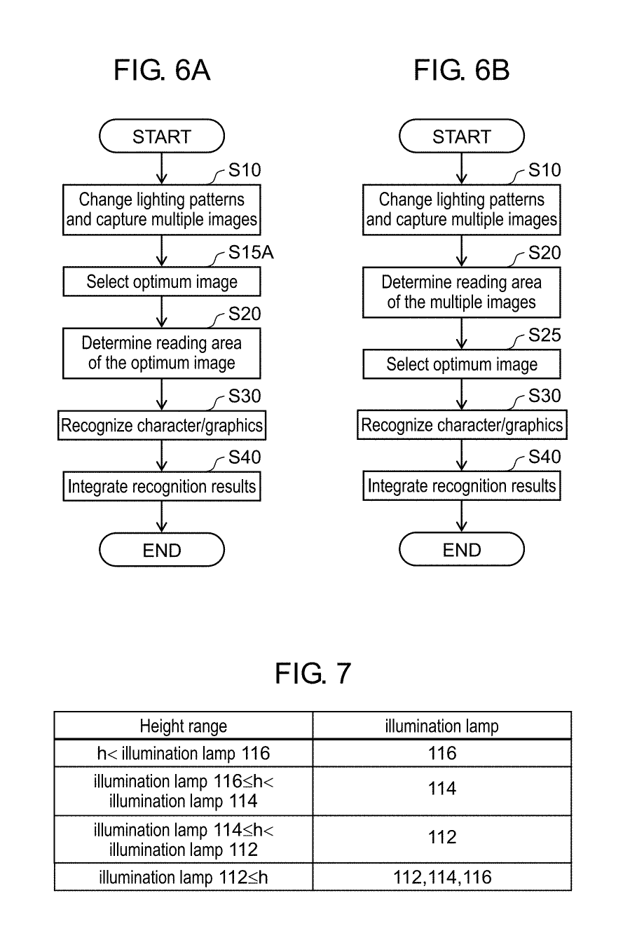

FIG. 6A is a flow chart illustrating Modification 1 of the operation for obtaining information by character/graphics recognition device 10. FIG. 6B is a flow chart illustrating Modification 2 of the operation for obtaining information by character/graphics recognition device 10.

In Modification 1, Step S15A of selecting one image suitable for character/graphics recognition (hereinafter referred to as an ‘optimum image’ in Modifications 1 and 2) from multiple images captured by imaging unit 100 is added to the above operation.

In Step S15A, reading area determination unit 210 selects one image based on pixel values of pixels in the multiple images captured by imaging unit 100.

As a specific example of selecting an image based on the pixel value, brightness of pixel at the same point in the multiple images is compared to estimate a distance from each of illumination lamps 112, 114, and 116, i.e., the height of meal box 900, which is the object. An image captured when inside the heating chamber is illuminated using the illumination lamp corresponding to this estimated height may be selected. In this case, the illumination lamp corresponding to the height is predetermined for each estimated height range and stored in memory 120 as data. Reading area determination unit 210 refers to the data in this step.

FIG. 7 is an example of data to be referred to. In this data, when estimated height h of the object is lower than the height of illumination lamp 116, an image captured while illumination lamp 116 illuminates inside the heating chamber is selected. When estimated height h of the object is same or higher than the height of illumination lamp 116 and also lower than the height of illumination lamp 114, an image captured while illumination lamp 114 illuminates inside the heating chamber is selected. The correspondence relation between the height range and illuminated lamp is prepared in design of the microwave oven, for example, and stored in memory 120.

Another example is to evaluate a picture quality (here, it means amount of contrast, noise, etc.) in the entire or predetermined area (e.g., the center part of image) of each image, based on the pixel value, and an image is selected by comparing evaluation results.

Modification 1 has less processing load on character/graphics recognition device 10, compared to determining the reading area and performing character recognition of all images captured, as in the aforementioned example of operation. Accordingly, a resource required in specifications for character/graphics recognition device 10 can be further reduced. Or, the final information obtained as a recognition result can be output in a short time, compared to the aforementioned example of operation.

Alternatively, steps up to determination of the reading area of all images captured (Step S20) are executed, and an optimum image may be selected based on the pixel value in the reading area of each image (Step S25), as in Modification 2 shown in FIG. 6B. Modification 1 can reduce processing load more, but Modification 2 has higher possibility of obtaining a character recognition result with higher accuracy because the picture quality in the reading area is evaluated.

### 4-2. Modification for Generating an Optimum Image

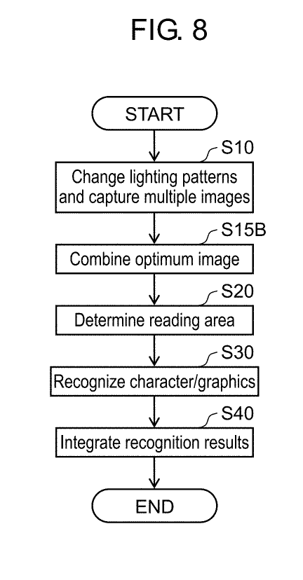

FIG. 8 is a flow chart illustrating Modification 3 of the operation for obtaining information by character/graphics recognition device 10.

In Modification 3, Step S15B of generating an image suitable for character/graphics recognition (hereinafter also referred to as an ‘optimum image’ in this Modification) by reading area determination unit 210 from multiple images captured by imaging unit 100 is added to the operation described in [3. Example of operation].

The images captured by imaging unit 100 have a common imaging area, and also a pixel value of a pixel at the same point in each image basically indicates information on the same point of the same object because the object is a still object. Using this fact, an average image is generated by calculating a mean value of pixel values of pixels at the same point in multiple images, and this average image may be used as the optimum image. Or, a difference image is generated from multiple images, and this difference image may be used as the optimum image.

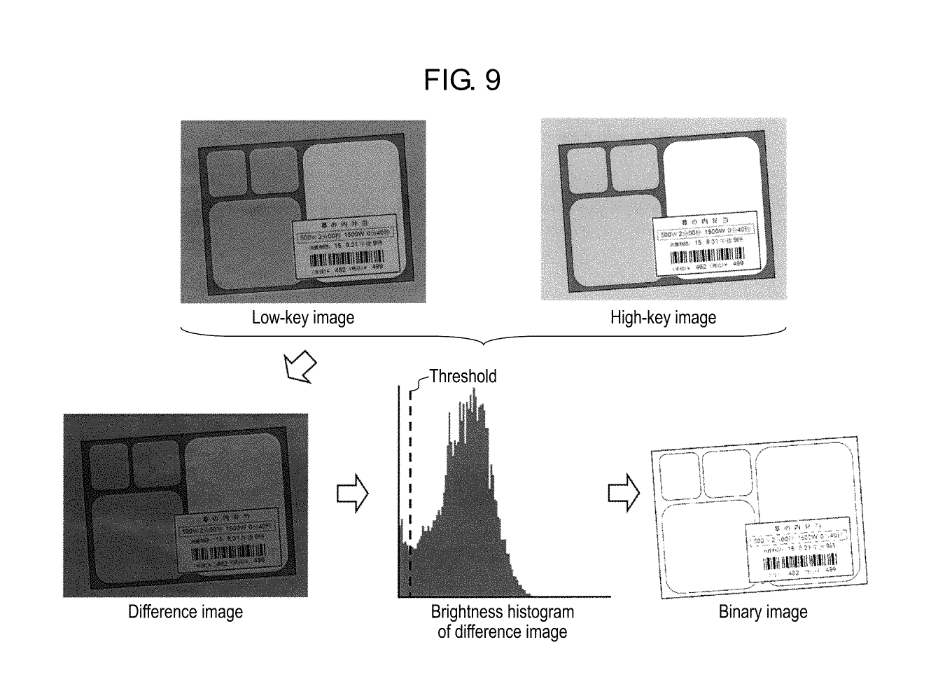

FIG. 9 shows an outline of character/graphics recognition using this difference image. In the example shown in FIG. 9, two images: a relatively dark entire image (low-key image in the figure) and a relatively bright entire image (high-key image in the figure), are first selected, typically based on a mean value of luminance of the entire image, from multiple images captured by imaging unit 100. Then, a difference image (bottom left in the figure) is generated based on a difference in pixel values of pixels at the same point in these images. A known method, such as a discrimination analysis method, is then used for generating a binary image from this difference image. Subsequently, reading area determination unit 210 determines a reading area by obtaining this binary image.

A method of generating the difference image is not limited to the method used in the example. For example, a difference image may be generated by identifying the maximum and minimum pixel values in the pixels at the same point in three or more images and calculating a difference between these maximum and minimum values. In addition, when a contrast of the entire difference image is insufficient (e.g., luminance distribution concentrates at the center of brightness histogram), luminance distribution in the difference image may be adjusted by normalization before the binarization process.

As described above, the optimum image may be generated from all images captured, or from some (at least two) of the images. Still more, on a pixel basis, a pixel value representing an extremely bright or dark luminance may be excluded from average or difference calculation.

Reading area determination unit 210 first combines two images out of three or more images to generate an optimum image candidate. When no extremely dark or extremely bright area exists (or its percentage accounts for less than a predetermined value in the entire image), this optimum image candidate is used as the optimum image. When there is an extreme area (or its percentage accounts for the predetermined value or above in the entire image), this optimum image candidate may be further combined with another image.

The modification enables to obtain an image suitable for character recognition even when all of images captured have a portion not suitable for character/graphics recognition.

### 4-3. Modification for Selecting an Optimum Image and its Correction

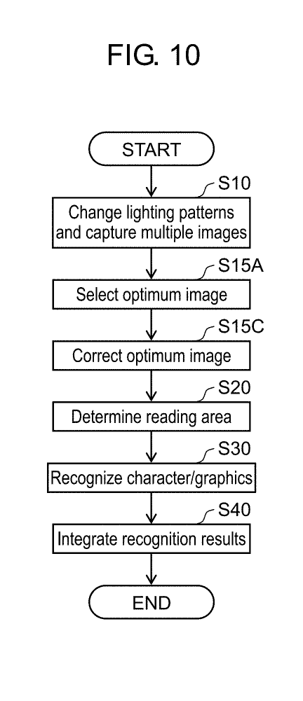

FIG. 10 is a flow chart illustrating Modification 4 of the operation for obtaining information by character/graphics recognition device 10.

In Modification 4, Step S15A of selecting one most suitable image for character/graphics recognition (hereinafter also referred to as an ‘optimum image’ in this Modification) from multiple images captured by imaging unit 100 and Step S15C of applying correction to this optimum image in order to increase accuracy of character/graphics recognition are added to the operation described in [3. Example of operation].

The image selected in Modification 1 is an image that most accurate character/graphics recognition can be expected in the images captured by imaging unit 100. However, a portion of the image may not be suitable for character/graphics recognition. For example, an extremely bright or dark area may be included. In this case, in this modification, reading area determination unit 210 corrects a portion not suitable for character/graphics recognition by using pixel values of a portion of an image not selected as the optimum image, corresponding to the portion not suitable for character/graphics recognition in the optimum image.

As a specific example of this correction, a pixel value of each pixel in a portion of another image corresponding to the pixel value of each pixel in a portion with insufficient brightness in the optimum image may be added. Or, a pixel value of each pixel in the portion with insufficient brightness and a pixel value of each pixel in the portion of another image corresponding to this portion may be averaged.

This Modification enables to obtain an image that character/graphics recognition with further higher accuracy can be expected even when the optimum image includes a portion not suitable for character/graphics recognition.

### 4-4. Modification for Evaluating an Image After Every Imaging

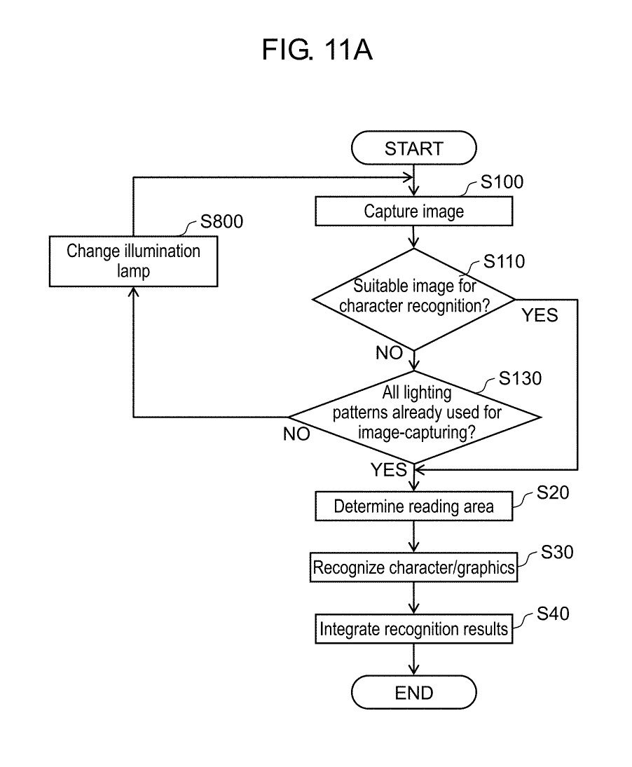

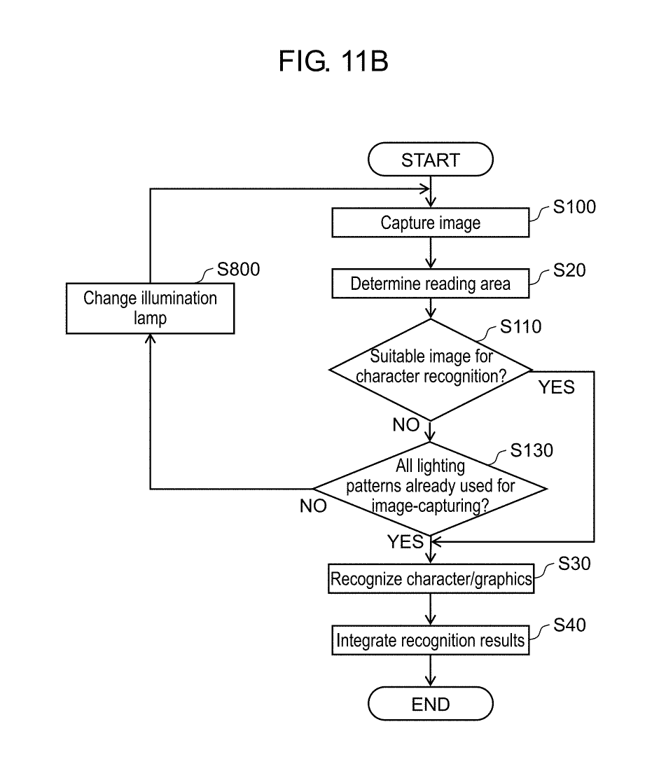

FIG. 11A and FIG. 11B are flow charts illustrating Modification 5 and Modification 6 of the operation for obtaining information by character/graphics recognition device 10, respectively.

In the operation described in [3. Example of operation], multiple lighting patterns are changed sequentially, and then an image is captured using each lighting pattern (Step S10).

In Modification 5, reading area determination unit 210 determines suitability of an image captured by imaging unit 220 for character/graphics recognition (Step S110) every time imaging unit 100 captures an image while inside the heating chamber is illuminated using a certain lighting pattern (Step S100). When recognition unit 220 determines that the image captured is suitable for character/graphics recognition (YES in Step S110), reading area determination unit 210 uses the aforementioned method to determine the reading area in this image (Step S20). When recognition unit 220 determines that the image captured by recognition unit 220 is not suitable for character/graphics recognition (NO in Step S110), controller 200 checks for other lighting pattern not yet applied (NO in Step S130), and makes illumination unit 110 illuminate inside the heating chamber using this not-yet-applied lighting pattern if there is (Step S800). Imaging unit 100 captures an image while inside the heating chamber is illuminated using a lighting pattern different from the previous pattern (Step S100). When all the lighting patterns have already been used for illumination to capture an image (YES in Step S130), the reading area is determined from the images already captured, according to the steps in one of aforementioned example of operation and its modifications (Step S20).

In determination in Step S110, for example, a picture quality (here, it means contrast or noise amount) of the entire image or predetermined area (e.g., center part of image) is evaluated based on pixel values.

Still more, as in the steps of Modification 6 shown in FIG. 11B, reading area determination unit 210 may determine the reading area in the image captured before determining the image in Step S110 of Modification 5, so as to perform determination in Step S110 by evaluating the picture quality based on pixel values in this determined reading area.

In the aforementioned example of operation and Modifications 1 to 4, the step of capturing an image (Step S10) is repeated at least for the number of lighting patterns adopted. Conversely, Modification 5 and Modification 6 require less number times of image-capturing (Step S100). Consequently, recognition result information may be output faster. In comparison between Modification 5 and Modification 6, time until outputting recognition result information can be further shortened in Modification 5. However, Modification 6 that determines the picture quality in the reading area has higher possibility of gaining a character/recognition result with higher accuracy.

Lighting by an illumination lamp at a higher position has less chance of forming a shadow of the object itself on the top face of the object, compared to lighting by an illumination lamp at a lower position, and thus there is a higher possibility of obtaining an image suitable for character/graphics recognition. Accordingly, in Modification 5 and Modification 6, the illumination lamps are preferably used in a sequence from an illumination lamp at a higher position, i.e., illumination lamp 112 in FIG. 1, for capturing an image. When uneven height distribution of a target object is identified in advance, an illumination lamp corresponding to the most frequent height of the object is preferably used for lighting first. In this case, the sequence of lighting the illumination lamps is stored in memory 120.

### 4-5. Modification for Performing Character Recognition After Capturing an Image Every Time

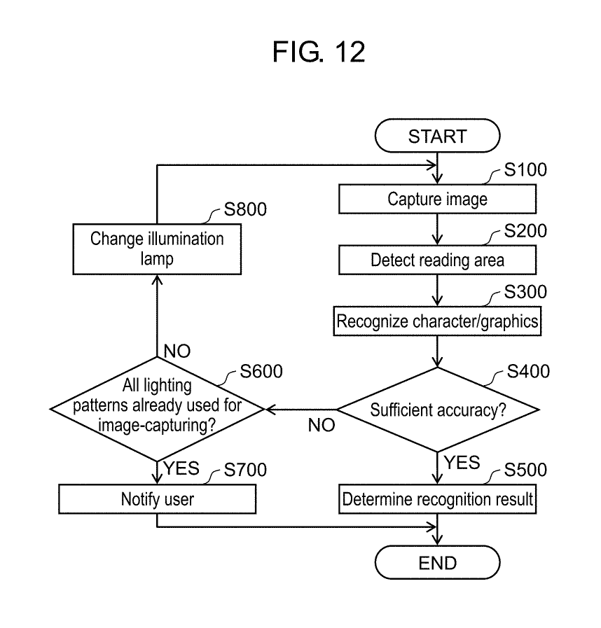

FIG. 12 is a flow chart illustrating Modification 7 of the operation for obtaining information by character/graphics recognition device 10.

In Modification 7, reading area determination unit 210 determines the reading area (Step S200) and recognition unit 220 performs character/graphics recognition in the reading area (Step S300) every time imaging unit 100 captures an image while the heating chamber is illuminated with a certain lighting pattern.

Then, recognition result integration unit 230 obtains the accuracy included in the recognition result information output from recognition unit 220 in Step S300 to determine whether or not the obtained accuracy is sufficient (Step S400). When the obtained accuracy is determined to be sufficient (YES in Step S400), recognition result integration unit 230 determines and outputs information typically on characters included in this recognition result information as final information (Step S500). When the obtained accuracy is determined to be insufficient (NO in Step S400), controller 200 checks for a lighting pattern not yet applied (NO in Step S600), and makes illumination unit 110 illuminate inside the heating chamber using this not-yet-applied lighting pattern if there is (Step S800). Imaging unit 100 then captures an image while inside the heating chamber is illuminated with a lighting pattern different from the previous pattern (Step S100). When all the lighting patterns have already been used for illumination to capture an image (YES in Step S600), recognition result integration unit 230 outputs a message, such as a failure of obtaining information, via a display unit or audio output unit (neither illustrated) provided in the microwave oven (Step S700).

Also in Modification 7, the recognition result information may be output faster than the aforementioned example of operation and its Modifications. Also in this Modification, illumination lamps are preferably used from that at a higher position, e.g., illumination lamp 112 in the example in FIG. 1, for illumination for capturing an image, due to the same reason as Modifications 5 and 6. Still more, when uneven height distribution of the object is identified in advance, an illumination lamp corresponding to the most-frequent height of the object is preferably used first for capturing an image. In this case, the lighting sequence of illumination lamps is stored in memory 120.

4-6. Modification for Combining Images after Capturing an Image Every Time

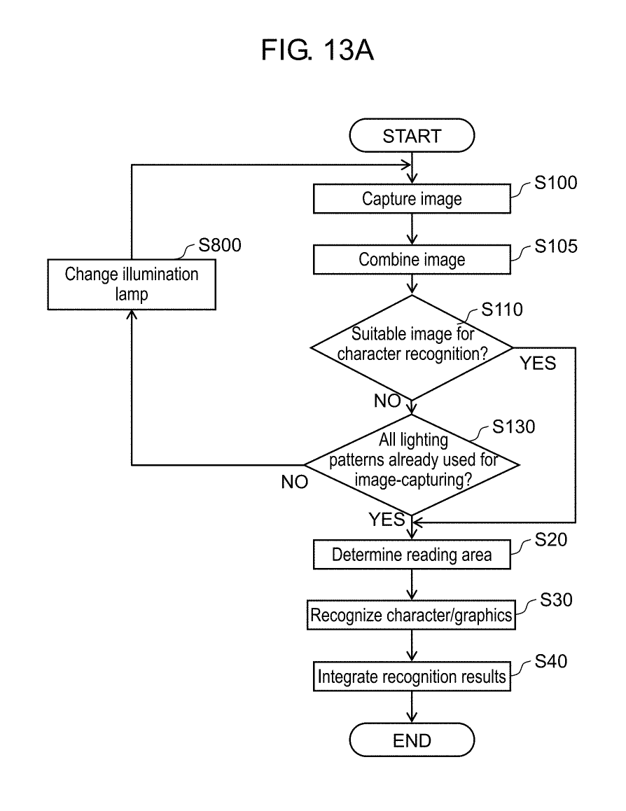

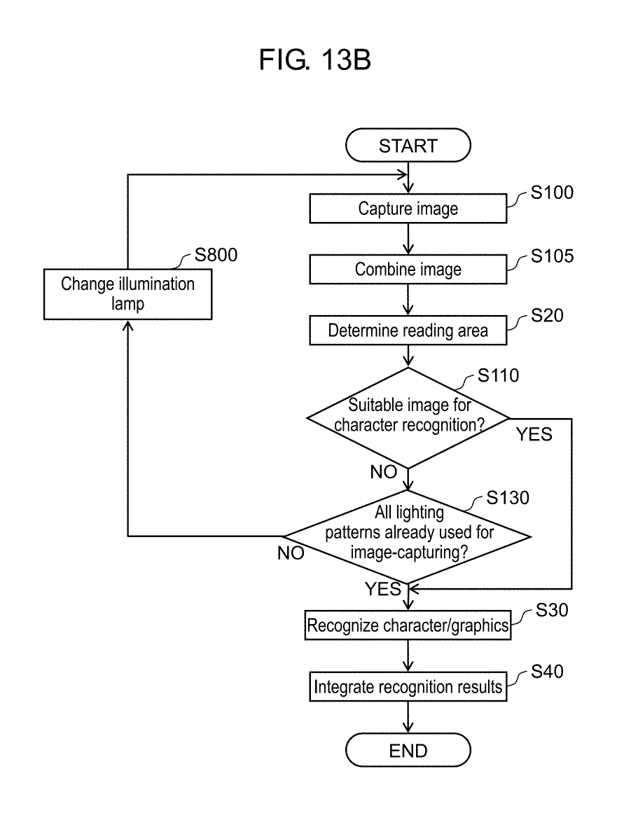

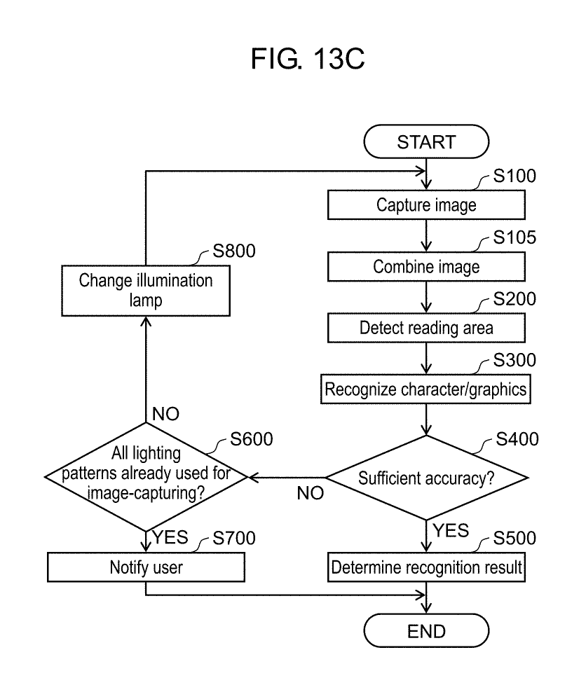

FIG. 13A to FIG. 13C are flow charts illustrating Modifications 8 to 10 of the operation for obtaining information by character/graphics recognition device 10.

In Modifications 5 and 6, whether or not an image is suitable for character recognition is determined (Step S110), a new image is captured using a different lighting pattern for illumination when the image is not suitable for character recognition (Step S800 and Step S100), and then whether or not this new image is suitable for character recognition is determined (Step S110). In Modification 7, a new image is captured while illuminated with a different lighting pattern (Step S800 and Step S100) when the accuracy of character/graphics recognition is insufficient (Step S400), and character/graphics recognition is applied to this new image (Step S300) to determine its accuracy. (Step S400).

In Modifications 8 to 10, when a determination result in Step S110 or Step S400 in Modifications 5 to 7 is negative, next new image is obtained by photographing and composition. Details of the composition are same as composition for generating the optimum image (Step S15B) in the steps described in aforementioned Modification 3. Subsequent steps same as those in

Modifications 5 to 7 are executed on this image obtained by composition.

In Modification 8 shown in FIG. 13A, reading area determination unit 210 obtains an image by composition (Step S105) and determines whether or not this obtained image is suitable for character/graphics recognition by recognition unit 220 (Step S110). This determination is same as determination in Step S110 in the steps for Modifications 5 and 6. When the image obtained by composition is determined to be suitable for character/graphics recognition by recognition unit 220 (YES in Step S110), reading area determination unit 210 determines a reading area in this image using aforementioned method (Step S20). When the image obtained by composition is determined to be not suitable for character/graphics recognition by recognition unit 220 (NO in Step S110), controller 200 checks for a lighting pattern not yet applied (NO in Step S130), and makes illumination unit 110 illuminate inside the heating chamber using this not-yet-applied lighting pattern if there is (Step S800). Imaging unit 100 captures an image while inside the heating chamber is illuminated using a lighting pattern different from the previous pattern (Step S100). Reading area determination unit 210 further combines a new image, using the new image captured, and determines whether or not the image obtained by the composition is suitable for character/graphics recognition by imaging unit 220 (Step S110).

Still more, as in the steps for Modification 9 shown in FIG. 13B, reading area determination unit 210 may determine a reading area of an image captured (Step S20) before determination of the image in Step S110 in Modification 8. Determination in Step S110 may be performed by evaluating a picture quality based on a pixel value in the reading area determined.

Still more, as in the steps for Modification 10 shown in FIG. 13C, reading area determination unit 210 may determine a reading area (Step S200) and recognition unit 220 may perform character/graphics recognition in the reading area (Step S300) every time reading area determination unit 210 combines an image (Step S105). Then, recognition result integration unit 230 obtains accuracy included in the recognition result information output from recognition unit 220 in Step S300 to determine whether or not obtained accuracy is sufficient (Step S400). When the obtained accuracy is determined to be sufficient (YES in Step S400), recognition result integration unit 230 determines and outputs information, typically on characters included in this recognition result information, as final information (Step S500). When the obtained accuracy is determined to be insufficient (NO in Step S400), controller 200 checks for a lighting pattern not yet applied (NO in Step S600) and makes illumination unit 100 illuminate inside the heating chamber using this not-yet-applied lighting pattern (Step S800). Imaging unit 100 captures an image while inside the heating chamber is illuminated with a lighting pattern different from the previous pattern (Step S100). When all lighting patterns have already been used for illumination for capturing an image (YES in Step S600), recognition result integration unit 230 outputs a message, such as a failure of obtaining information, via a display unit or audio output unit (neither illustrated) provided in the microwave oven (Step S700).

In the above description, steps on and after changing a lighting pattern and capturing an image do not need to be executed when a first image captured is already suitable for character recognition or a character recognition result with sufficient accuracy is obtained, also in steps for Modifications 8 to 10.

The steps for Modifications 8 to 10 can further reduce the number of times of capturing an image (Step S100), compared to that for the example of operation and its Modifications 1 to 4. Consequently, the recognition result information may be output faster. Still more, compared to Modifications 5 to 7, Modifications 8 to 10 take a longer time until output of the recognition result information because a step of combining images is added. However, since an image suitable for character/graphics recognition not obtainable with a single image is used, a more accurate character/graphics result can be obtained.

### 5. Other Modifications

The above description describes the operation of character/graphics recognition device 10, taking an example of turning on only one illumination lamp for each image-capturing. However, lighting patterns that controller 200 applies to illumination unit 110 in the exemplary embodiments are not limited to turning on only one illumination lamp at a time. A combination of turning on multiple illumination lamps and turning off others may be included in a lighting pattern applied to illumination unit 110. Still more, when external light is applied to the object while an opening of the heating chamber is open, all the illumination lamps may be turned off for image-capturing. This pattern of turning off all illumination lamps may also be included in the above lighting patterns. Note that all combinations of turning on and off multiple illumination lamps do not need to be adopted.

In the above configuration, imaging unit 100 captures an image of the object from the above, but the image may be captured from a different angle, such as in the horizontal direction.

Still more, depending on the object or information to be read, characters, symbols, or bar codes may not be indicated in a specific reading area. In this case, reading area determination unit 210 sets the entire image to the reading area.

In the above configuration, multiple illumination lamps are disposed at different height levels in order to capture an image suitable for character/graphics recognition, regardless of changes in the height of object placed inside. However, an image suitable for character/graphics recognition can be captured, regardless of changes in the depth of the object placed inside, by aligning the illumination lamps in the horizontal direction. Furthermore, the illumination lamps may be disposed in both horizontal and vertical directions. In this case, an image suitable for character/graphics recognition can be captured, regardless of changes in the position or size of the object and also direction of reading area, in addition to the height of the object placed inside.

### 6. Advantages

As described above, the exemplary embodiment relates to character/graphics recognition device 10 for obtaining information by recognizing a character or graphic affixed to an object in a predetermined space. Character/graphics recognition device 10 includes controller 200, imaging unit 100, illumination unit 110, reading area determination unit 210, and recognition unit 220.

Imaging unit 100 captures an image in a predetermined imaging area including an object in the above predetermined space.

Illumination unit 110 includes multiple illumination lamps 112, 114, and 116 emitting light into the predetermined space from different positions. Controller 200 applies a lighting pattern that is a combination of turning on and off of illumination lamps 112 and 114, and 118 to make illumination unit 110 illuminate the aforementioned space with the lighting pattern applied. In the present disclosure, the word “illuminate” includes the case of turning off all of illumination lamps 112, 114, and 116. Imaging unit 100 captures an image in the predetermined imaging area while illumination unit 110 illuminates the space using the lighting pattern applied.

More specifically, controller 200 sequentially changes the lighting pattern to apply to illumination unit 110 to illuminate the predetermined space with different multiple lighting patterns.

Controller 200 also controls the timing to capture an image by imaging unit 100. More specifically, controller 200 makes imaging unit 100 capture an image in the predetermined imaging area including the object for multiple times while illumination unit 110 illuminates the space with each of the lighting patterns. Controller 200 also makes reading area determination unit 210 determine a reading area in at least one of the images. For example, reading area determination unit 210 selects one image based on pixel values of pixels in the images, and determine the reading area in this selected image. Alternatively, a reading area candidate in each of the images is determined to obtain multiple provisional reading areas. Based on pixel values of pixels in these provisional reading areas, one reading area may be selected.

This limits the reading area to execute character/graphics recognition in the multiple images. Accordingly, character/graphics recognition is more efficiently performed, compared to recognizing all of the images or the entire area of one image. In addition, since the reading area is selected from the images captured by changing illumination lamps to be turned on, information can be obtained from an image more suitable for character/graphics recognition.

Still more, in the exemplary embodiment, controller 200 may make reading area determination unit 210 generate an average image from at least two images and determine a reading area in this average image. Or, controller 200 may generate a difference image showing a difference between the maximum and minimum pixel values of pixels at the same point in at least two images, and determine a reading area in this difference image. Still more, controller 200 may make reading area determination unit 210 select one image based on pixel values of pixels in the multiple images, and determine a reading area in the selected image after correcting a partial area in the selected image using a partial area in another image in the multiple images.

This enables to obtain a reading area suitable for character/graphics recognition even when no images captured by changing the illumination lamps to illuminate have the reading area with sufficient picture quality for character/graphics recognition.

Furthermore, character/graphics recognition device 10 may include recognition result integration unit 230. In this case, controller 200 makes reading area determination unit 210 obtain multiple reading areas by determining a reading area in each of the images, and makes recognition unit 220 perform character/graphics recognition in each of these reading areas and output recognition result information including information obtained on each of the reading areas by character/graphics recognition and accuracy of the information. Then, controller makes recognition result integration unit 230 integrate information based on the accuracy of each reading area.

This enables to select a result with higher possibility of the highest accuracy from character recognition results obtained by capturing images while different illumination lamps are turned on. More beneficial information can thus be obtained.

Still more, controller 200 may make reading area determination unit 210 determine whether or not the image is suitable for recognition by recognition unit 220, based on pixel values of at least partial pixels of the image. When reading area determination unit 210 determines that the image is not suitable for recognition by recognition unit 220, controller 200 makes illumination unit 110 illuminate the space with a lighting pattern different from that used for previous image-capturing, and makes imaging unit 100 further capture an image while illumination unit 110 illuminates the space using this different lighting pattern. Alternatively, when reading area determination unit 210 determines that the image is not suitable for character/graphics recognition by recognition unit 220, controller 200 may make reading area determination unit 210 obtain a new image by combining the image already determined and an image further captured subsequently after changing an illumination lamp, and determine whether or not the new image is suitable for recognition by recognition unit 220, based on pixel values of at least partial pixels of this new image.

Accordingly, whether or not the image is suitable for character/graphics recognition is determined every time an image is captured. When the first image captured is already suitable for character/graphics recognition, information can be obtained faster, compared to the sequence of determining whether or not the image is suitable for character/graphics recognition by comparing multiple images.

Still more, controller 200 makes recognition unit 220 perform character/graphics recognition in the reading area and output recognition result information including information obtained by character/graphics recognition and accuracy of the information. Controller 200 may then make recognition result integration unit 230 determine whether or not this accuracy is less than or not less than a predetermined threshold. When recognition result integration unit 230 determines that the accuracy is less than the predetermined threshold, controller 200 may make illumination unit 110 illuminate the space with a lighting pattern different from that used in previous image-capturing, and make imaging unit 100 further capture an image while illumination unit 110 illuminates the space with this different lighting pattern. Alternatively, when recognition result integration unit 230 determines that the accuracy is less than the predetermined threshold, controller 200 makes reading area determination unit 210 obtain a new image by combining the image already determined previously and an image further captured after changing an illumination lamp, and determine the reading area in this new image. Then, controller 200 may make recognition unit 220 perform character/graphics recognition in the reading area of the new image, and output recognition result information including information obtained by this character/graphics recognition and accuracy of the information, and make recognition result integration unit 230 determine whether or not this accuracy is less than or not less than the predetermined threshold.

Accordingly, whether or not an accuracy of information obtained from the image is sufficient is determined every time an image is captured. When the accuracy of information obtained from first image is already sufficient, information can be obtained faster, compared to the sequence of determining whether or not accuracy of information obtained is sufficient after comparing information obtained from multiple images.

An example of information obtained in this way includes a heating time, expiration date, consumption deadline, and preservation temperature range of food. These pieces of information may be used for controlling a microwave oven or refrigerator, or displayed on a display unit provided in these devices. Another example is to use information indicated on an invoice of a package or information on a precaution label attached to an external surface of a package for managing packages in a delivery box.

### Second Exemplary Embodiment

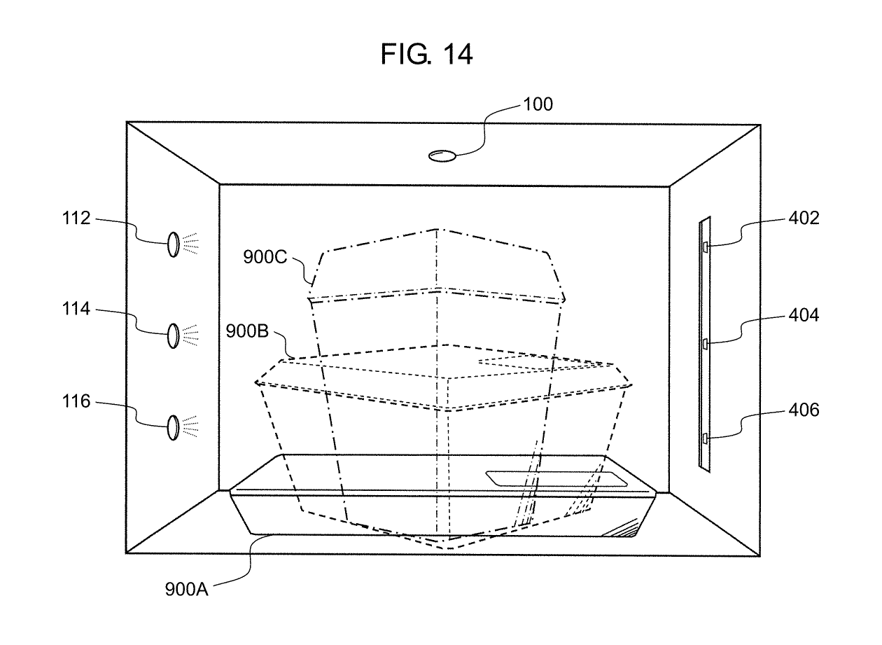

The second exemplary embodiment is described with reference to FIG. 14 to FIG. 16.

### 1. Outline

Also in the second exemplary embodiment, an image suitable for character/graphics recognition of an object with different sizes and shapes placed inside a heating chamber is captured, using an illumination unit including multiple illumination lamps provided on the side face of heating chamber for emitting light to inside the heating chamber from different height levels. This is same as that in the first exemplary embodiment.

In the second exemplary embodiment, a point different from the first exemplary embodiment is that a height of an object is detected before the imaging unit captures an image, and the illumination unit illuminates using an illumination lamp corresponding to the height.

FIG. 14 illustrates an outline of the character/graphics recognition device in the second exemplary embodiment. The character/graphics recognition device in the second exemplary embodiment further includes multiple optical sensors 402, 404, and 406. This is the point that differs from the character/graphics recognition device in the first exemplary embodiment. Optical sensors 402, 404, and 406 are installed on the side face of the heating chamber at different high levels. The sensors detect brightness inside the heating chamber at each level. In the example, optical sensors 402, 404, and 406 are disposed at substantially the front of illumination lamps 112, 114, and 116, respectively.

As shown in FIG. 14, brightness is detected at different height levels to provide brightness information obtained by detection at each level (hereinafter referred to as ‘brightness information’) for estimating a height of an object. For example, FIG. 14 shows three objects 900A, 900B, and 900C with different heights. The height of object 900A is lower than positions of all illumination lamps and optical sensors. The height of object 900B is higher than positions of illumination lamp 116 and optical sensor 406, but lower than positions of illumination lamp 114 and optical sensor 404. The height of object 900C is higher than positions of illumination lamp 114 and optical sensor 404, but lower than positions of illumination lamp 112 and optical sensor 402. A relation between heights of these objects and brightness detected by each optical sensor is described with reference to an example.

In the example, assume that all illumination lamps 112, 114, and 116 are turned on, and have substantially equivalent light intensity. When object 900A is placed inside the heating chamber in this situation, lights emitted from all illumination lamps reach optical sensors 402, 404, and 406 without being blocked. There is thus no significant difference in brightness detected by the optical sensors. When object 900B is placed inside the heating chamber, most of light emitted from illumination lamp 116 is blocked by object 900B, and does not reach the optical sensors. In particular, brightness detected by optical sensor 406 becomes significantly lower than that detected by optical sensors 402 and 404 because light emitted at the front is blocked and optical sensor 406 cannot receive the light. When object 900C is placed inside the heating chamber, most of light emitted from illumination lamps 114 and 116 is blocked by object 900C and does not reach the optical sensors. In particular, brightness detected by optical sensors 404 and 406 becomes significantly lower than that detected by optical sensor 402 because light emitted at the front is blocked and optical sensors 404 and 406 cannot receive the light.

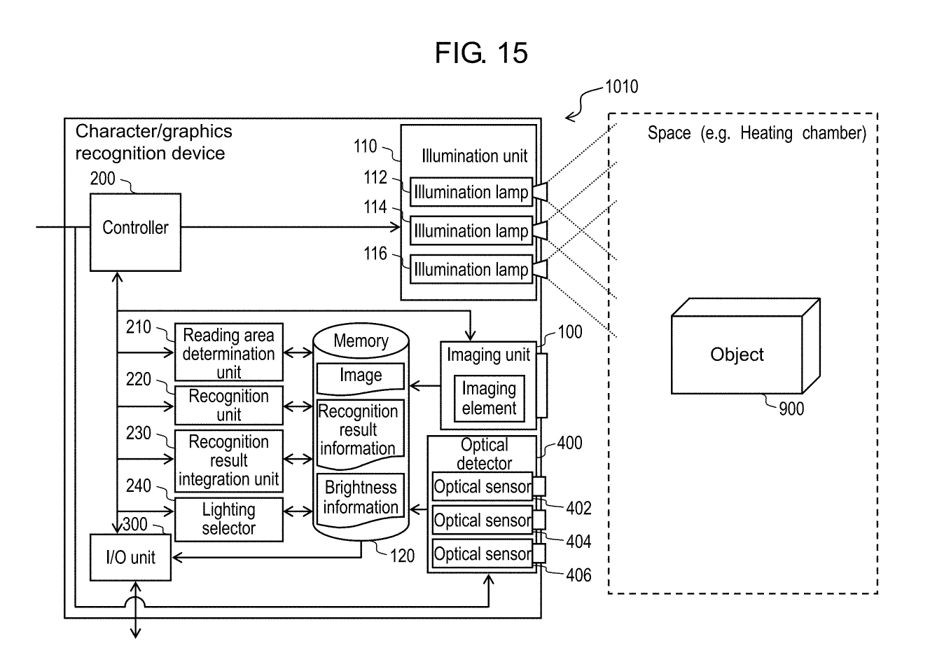

As described above, a difference in brightness detected by each optical sensor differs by height of the object placed in the space. Accordingly, height of an object can be estimated based on brightness information that is information on brightness detected by the optical sensors. By specifying each illumination lamp suitable for capturing an image of an object at each height level in advance, an illumination lamp to be turned on is selected based on estimated object height, in order to capture an image suitable for character/graphics recognition. Next is described configuration for achieving the operation of the character/graphics recognition device as described above, with reference to FIG. 15.

### 2. Configuration

FIG. 15 is a block diagram illustrating a configuration of character/graphics recognition device 1010 in the second exemplary embodiment.

Character/graphics recognition device 1010 includes optical detector 400 having optical sensors 402, 404, and 406, and lighting selector 240, in addition to the configuration of character/graphics recognition device 10 in the first exemplary embodiment. Memory 120 further stores the brightness information. Components same as that of character/graphics recognition device 10 in the first exemplary embodiment are given the same reference marks to omit their duplicate detailed description.

Controller 200 controls illumination unit 110 to emit light from at least one of illumination lamps 112, 114, and 116 to illuminate the space. As shown in FIG. 15, illumination lamps 112, 114, and 116 are aligned linearly.

Optical detector 400 is a component including optical sensors 4002, 404, and 406 in aforementioned predetermined space (a heating chamber in the exemplary embodiment), and is installed on a face opposing illumination unit 110. Controller 200 controls optical detector 400 to output brightness detected by each of optical sensors 402, 404, and 406 as the brightness information while illumination unit 110 emits light from all the illumination lamps to illuminate the heating chamber. This brightness information is stored in memory 120. A range of known optical sensors are used for optical sensors 402, 404, and 406.

Lighting selector 240 is a functional component provided and controlled by controller 200 that executes a program stored in memory 120 to perform the next operation. Lighting selector 240 estimates height of object 900 in the heating chamber based on the brightness information output from optical detector 400. Estimation is made, for example, based on intensity of brightness detected by each sensor as described in the above outline. Another example is to estimate based on intensity of brightness detected by each sensor compared with a predetermined threshold of intensity. A lighting pattern to be applied for image-capturing is selected according to this estimated height. The selection is made, for example, with reference to data shown in FIG. 7 referred to in Modification 1 in the first exemplary embodiment. Using this data, an illumination lamp at the lowest position in the illumination lamps whose emitted light is not blocked by object 900 is selected as illumination lamp 116 for lighting. When object 900 blocks light emitted from all illumination lamps, all illumination lamps are selected for lighting as illumination lamps 112, 114, and 116. This is to make the top face of object 900 bright as much as possible by light reflected in the heating chamber because no direct light from the illumination lamps reach the top face of object 900.

### 3. Example of Operation

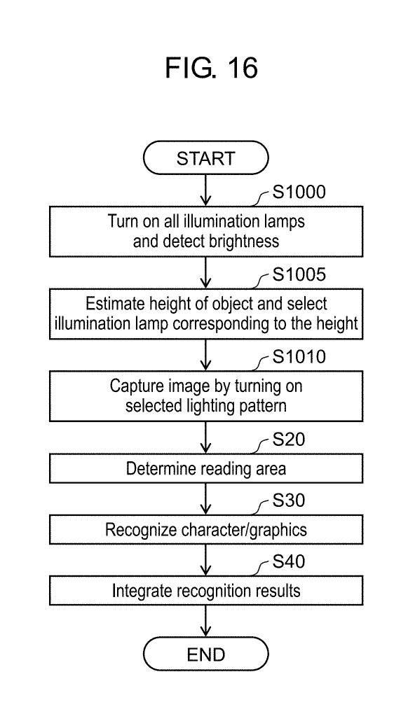

The operation of character/graphics recognition device 1010 as configured above is described below. FIG. 16 is a flow chart illustrating an example of the flow of operation of character/graphics recognition device 1010. The operation is triggered when, for example, controller 200 receives a request for a character/graphics recognition result from the microwave oven that has received user's input of instruction for starting auto-heating, or detected closing of its door after a heating object is placed in the heating chamber.

The operation shown in FIG. 16 includes three steps instead of the first step of capturing multiple images by changing illumination lamps (Step S10) in the operation in the first exemplary embodiment in FIG. 3. The subsequent steps are the same. Description below centers on a difference with the first exemplary embodiment.

### 3-1. Detecting Brightness

First, in Step S1000, controller 200 turns on all illumination lamps 112, 114, and 116 of illumination unit 110 to illuminate object 900 placed in the heating chamber. Controller 200 then makes optical detector 400 output the brightness information, which is brightness inside the heating chamber detected by each of optical sensors 402, 404, and 406 of optical detector 400 while illumination unit 110 illuminates the heating chamber. Memory 120 stores data of this output brightness information.

### 3-2. Estimating Height Estimation and Selecting Illumination Lamp

Next, in Step S1005, lighting selector 240 obtains the brightness information data from memory 120. Lighting selector 240 estimates height of object 900 based on brightness detected by each of optical sensors 402, 404, and 406 indicated in this data. This estimation is performed based on the aforementioned relation with brightness intensity detected by each optical sensor. When brightness detected by all optical sensors is, for example, lower than intensity of predetermined threshold, lighting selector 240 may estimate that object 900 has height higher than the level of illumination lamp 112 at the highest position.

Lighting selector 240 then selects an illumination lamp corresponding to this estimated height. This selection is performed with reference to data indicating a corresponding relation of an object height range and an illumination lamp lighted for capturing an image, typically shown in FIG. 7. A combination of selected illumination lamps is sent to controller 200.

### 3-3. Capturing an Image

In Step S1010, controller 200 makes illumination unit 110 illuminate inside the heating chamber by turning on illumination lamps for achieving the combination of illumination lamps informed. In addition, controller 200 makes imaging unit 100 capture an image in a predetermined imaging area while illumination unit 110 illuminates inside the heating chamber.

### 3-4. Determining a Reading Area and Recognizing a Character or Graphic

The operation of character/graphics recognition device 1010 in the steps on and after Step S20 is basically the same as the operation of character/graphics recognition device 10 in the first exemplary embodiment. However, integration of recognition results is not required when an image is captured only once after the above determination.

### 4. Modification

The configuration and operation described above are just an example, and a range of modifications is applicable.

For example, in the above description, each illumination lamp is retained in the state of on or off during image-capturing. However, brightness of each illumination lamp may be adjusted at multistage. The lighting patterns in the present disclosure include brightness of each illumination lamp.

Still more, a height range may be estimated at furthermore fine levels by increasing the number of brightness levels to be detected by each optical sensor or optical sensors installed at different height levels. Then, brightness corresponding to the height range estimated at multistage may be selected from the aforementioned brightness at multiple levels.

In the above operation, all illumination lamps are turned on for estimating height. However, some of illumination lamps may not be turned on for estimating height. For example, only one illumination lamp may be turned on to estimate the object height based on a difference in brightness detected by each optical sensor between presence and absence of the object in the space.

However, a method of turning on multiple illumination lamps enables to estimate height more accurately

In the above configuration, multiple illumination lamps are installed at different height levels for estimating height of object 900 placed in the space. However, the illumination lamps may be aligned horizontally for estimating object 900 placed in the space. Furthermore, the illumination lamps may be aligned both horizontally and vertically. In this case, the position and size of object 900 placed in the space can be estimated, and illumination lamps to be turned on for capturing an image or brightness of each illumination lamp (lighting pattern) may be selected based on this estimation result.

Furthermore, character/graphics recognition device 1010 captures multiple images by turning on different illumination lamps for obtaining an image suitable for character/graphics recognition, based on height (or also position and posture) of object 900, and combines these images. Or, character/graphics recognition results of images may be integrated. In this case, character/graphics recognition device 1010 executes the operation in the example of operation in the first exemplary embodiment or its Modifications 1 to 6 after multiple images are captured.

### 5. Advantages

As described above, character/graphics recognition device 1010 includes optical detector 400 and lighting selector 240, in addition to the configuration in character/graphics recognition device 10. Optical detector 400 includes multiple optical sensors installed on the side of the space at different height levels for detecting brightness inside the space.

Controller 200 makes illumination unit 110 emit light from one or more of illumination lamps 112, 114, and 116 to illuminate the space. Controller 200 also makes optical detector 400 output the brightness information, which is brightness inside the space detected by each of the optical sensors while illumination unit 110 illuminates the space. Controller 200 also makes lighting selector 240 estimate height of object 900 based on the brightness information, and select a combination of illumination lamps corresponding to this estimated height.

Accordingly, an image of object 900 suitable for obtaining information by character/graphics recognition can be promptly obtained, corresponding to estimated height of object 900.

### Other Exemplary Embodiments

The first and second exemplary embodiments are described above as examples of disclosed technology. However, the disclosed technology may be embodied in still other ways. It should be understood that all modifications, replacements, additions, and omissions to the embodiments fall within the scope of the present disclosure. In addition, a new embodiment may also be feasible by combining components of the first and second exemplary embodiments described above.

Still more, in the above exemplary embodiments, the components may be practiced as a method including procedures for executing each component as steps.

Still more, in the above exemplary embodiments, the components may be practiced by configuring dedicated hardware or executing a software program appropriate for each component. Each component may also be achieved by reading and executing a software program recorded in a storage medium, such as a hard disk and semiconductor memory, by a program execution unit, such as a CPU and processor. An example of software for achieving the character/graphics recognition device in the above exemplary embodiments and their modifications is described below.

This program is a character/graphics recognition program for obtaining information by recognizing characters or graphic affixed to an object in a predetermined space. The controller is connected to the illumination unit including multiple illumination lamps for illuminating the predetermined space by emitting light from different positions, and the imaging unit for capturing an image in a predetermined imaging area including the object in the space. The program makes the controller control the illumination unit by applying the lighting pattern that is a combination of turning on and off of the illumination lamps. The program also makes the controller control the imaging unit to capture an image in the imaging area while the illumination unit illuminates the predetermined space. The program still further controls the controller to recognize a character or graphic in the image captured by the imaging unit to obtain information.

The exemplary embodiments are described above as examples of the technology in the present disclosure. For this purpose, attached drawings and detailed description are provided.

Accordingly, components indicated in the attached drawings and detailed description include those that are not essential for solving disadvantages in addition to the components essential for solving the disadvantages, in order to illustrate the technology. It is thus apparent that indication of not essential components in the attached drawings and detailed description do not immediately mean that they are essential components.

Furthermore, since the exemplary embodiments are considered in all respects as illustrative, all modifications, replacements, additions, and omissions which come within the scope and range of equivalency of the claims are therefore intended to be embraced therein.

### INDUSTRIAL APPLICABILITY

The present disclosure is applicable to devices for obtaining information by recognizing a character or graphic affixed to an object in a space that can be closed. More specifically, the present disclosure is applicable to devices for recognizing a character or graphic by capturing an image of an object inside a chamber, such as a microwave oven, coin-operated locker, delivery box, and refrigerator.

What is claimed is:

1. A character/graphics recognition device configured to obtain information by performing recognition of a character or graphic affixed to an object in a predetermined space, the character/graphics recognition device comprising:
a controller;
an imaging unit configured to capture an image in a predetermined imaging area including the object;
an illumination unit including a plurality of illumination lamps for emitting light from different positions to illuminate the predetermined space; and
a recognition unit configured to obtain the information by recognizing the character or graphic in the image captured by the imaging unit, and output recognition result information including the information obtained,
wherein
the controller applies a lighting pattern to the illumination unit and controls a timing to capture the image by the imaging unit, the lighting pattern being a combination of turning on and off of the plurality of illumination lamps.

2. The character/graphics recognition device of claim 1, further comprising a reading area determination unit configured to determine a reading area including a target of the recognition in the image, based on a pixel value of the image captured by the imaging unit.

3. The character/graphics recognition device of claim 2,
wherein
the controller causes:
the illumination unit to illuminate the predetermined space using a plurality of different lighting patterns by sequentially changing the lighting pattern to be applied, the plurality of different lighting patterns each being the lighting pattern,
the imaging unit to capture a plurality of images while the predetermined space is illuminated using each of the plurality of different lighting patterns by the illumination unit, and
the reading area determination unit to determine the reading area in at least one of the plurality of images.

4. The character/graphics recognition device of claim 3,
wherein
the controller causes:
the reading area determination unit to select one image from the plurality of images based on a pixel value of a pixel in each of the plurality of images, and determine the reading area in the selected image.

5. The character/graphics recognition device of claim 3,
wherein
the controller causes:
the reading area determination unit to generate an average image from at least two of the plurality of images, and determine the reading area in the average image.

6. The character/graphics recognition device of claim 3,
wherein
the controller causes:
the reading area determination unit to generate a difference image indicating a difference between a maximum pixel value and a minimum pixel value among pixel values of pixels at a same point in at least two of the plurality of images, and determine the reading area in the difference image.

7. The character/graphics recognition device of claim 3,
wherein
the controller causes:
the reading area determination unit to select one image based on a pixel value of a pixel included in each of the plurality of images, correct a partial area of the selected image using a partial area of another image in the plurality of images, and then determine the reading area in the selected image.

8. The character/graphics recognition device of claim 3,
wherein
the controller causes:
the reading area determination unit to obtain a plurality of provisional reading areas by determining a candidate of the reading area in each of the plurality of images, and to determine the reading area by selecting from the plurality of provisional reading areas based on a pixel value of a pixel included in each of the plurality of provisional reading areas.

9. The character/graphics recognition device of claim 3, further comprising a recognition result integration unit,
wherein
the controller causes:
the reading area determination unit to obtain a plurality of reading areas by determining the reading area in each of the plurality of images,
the recognition unit to output the recognition result information, including the information obtained by the recognition and accuracy of the information, on each of the plurality of reading areas by performing the recognition in each of the plurality of reading areas, and
the recognition result integration unit to integrate the information on each of the plurality of reading areas based on the accuracy.

10. The character/graphics recognition device of claim 2,
wherein
the controller causes the reading area determination unit to examine whether or not the image is suitable for recognition by the recognition unit based on pixel values of at least some of pixels of the image,
when the reading area determination unit determines that the image is not suitable for recognition by the recognition unit, the controller applies another lighting pattern different from the lighting pattern to the illumination unit, and causes the imaging unit to further capture the image while the another lighting pattern is applied to the illumination unit, and
when the reading area determination unit determines that the image is suitable for recognition by the recognition unit, the controller causes the reading area determination unit to determine the reading area.

11. The character/graphics recognition device of claim 2, further comprising a recognition result integration unit,
wherein
the controller causes:
the recognition unit to output the recognition result information, including the information obtained by the recognition and accuracy of the information, by performing the recognition in the reading area, and
the recognition result integration unit to examine whether the accuracy is less than or not less than a predetermined threshold, and
when the recognition result integration unit determines that the accuracy is less than the predetermined threshold, the controller sequentially changes the lighting pattern to be applied to the illumination unit to illuminate the predetermined space using a plurality of different lighting patterns, and causes the imaging unit to further capture the image while the space is illuminated using each of the plurality of different lighting patterns by the illumination unit.

12. The character/graphics recognition device of claim 10,
wherein
when the reading area determination unit determines that the image is not suitable for recognition by the recognition unit,
the controller causes the reading area determination unit to obtain a new image by combining the image determined and the image further captured, and examine whether or not the new image is suitable for recognition by the recognition unit based on pixel values of at least partial pixels of the new image.

13. The character/graphics recognition device of claim 11,
wherein
when the recognition result integration unit determines that the accuracy is less than the predetermined threshold,
the controller causes:
the reading area determination unit to obtain a new image by combining the image determined and the image further captured, and determine a reading area in the new image,
the recognition unit to output the recognition result information, including the information obtained by the recognition and accuracy of the information, by performing the recognition in the reading area in the new image, and
the recognition result integration unit to examine whether the accuracy is less than or not less than the predetermined threshold.

14. The character/graphics recognition device of claim 1, further comprising an optical detector including a plurality of optical sensors for detecting brightness inside the predetermined space, the plurality of optical sensors being installed on an opposing face of the illumination unit including the plurality of illumination lamps arranged in a row,
wherein
the controller causes:
the illumination unit to emit the light from at least one of the plurality of illumination lamps to illuminate the predetermined space, and
the optical detector to output brightness information, the brightness information being brightness inside the predetermined space detected by each of the plurality of optical sensors while the illumination unit illuminates the predetermined space, and
the controller further estimates a position of the object based on the brightness information, selects the lighting pattern corresponding to the estimated position, and causes the illumination unit to illuminate the predetermined space using the selected lighting pattern.

15. A method of obtaining information by recognizing a character or graphic affixed to an object in a predetermined space, comprising:
illuminating the predetermined space by applying a lighting pattern to an illumination unit including a plurality of illumination lamps for emitting light from different positions to illuminate the predetermined space, the lighting pattern being a combination of turning on and off of the plurality of illumination lamps;
capturing an image in a predetermined imaging area while the lighting pattern is applied to the illumination unit to illuminate the predetermined space; and
obtaining the information by recognizing the character or graphic in the captured image.

16. A character/graphics recognition program for obtaining information by recognizing a character or graphic affixed to an object in a predetermined space, the program being executed by a controller, the controller being connected to:
an illumination unit including a plurality of illumination lamps for emitting light from different positions to illuminate the predetermined space; and
an imaging unit configured to capture an image in a predetermined imaging area including the object,
wherein
the controller causes:
the illumination unit to illuminate the predetermined space by applying a lighting pattern, the lighting pattern being a combination of turning on and off of the plurality of illumination lamps, and
the imaging unit to capture the image in the predetermined imaging area while the illumination unit illuminates the predetermined space, and
the controller further obtains the information by recognizing the character or graphic in the image captured by the imaging unit.
